(19) United States
(12) Patent Application Publication
(10) Pub. No.: US 2005/0209810 A1
(43) Pub. Date: Sep. 22, 2005

(54) Measuring instrument with sensors

(75) Inventors: Didier Piaud, Paris (FR); Francisque Pion, Paris (FR)

Correspondence Address: LEYDIG VOIT & MAYER, LTD, 700 THIRTEENTH ST. NW, SUITE 300, WASHINGTON, DC, 20005-3960, US

(73) Assignee: Chauvin Arnoux, Neuilly Sur Seine (FR)

(21) Appl. No.: 11/072,639

(22) Filed: Mar. 7, 2005

(30) Foreign Application Priority Data
Mar. 10, 2004 (FR) 04 02 509

(51) Int. Cl. G01L 15/00

(52) U.S. Cl. 702/121

(57) ABSTRACT

A measuring instrument with active and/or passive sensors, and a connecting device enabling one to associate any one of the sensors with the measuring instrument. The connecting device enables one to identify the sensor and to activate at least one function for protection of the user of the measuring instrument determined according to characteristics of the sensor connected. For this purpose, a multi-point connector allowing identification of the sensor chosen, activation of the protection, and establishment of a direct link for transmission of measurement signals from the sensor to the measuring instrument.

The invention relates to an arrangement of a measuring instrument with a family of active and/or passive sensors.

When using a measuring instrument capable of being used for different types of quantities to be measured, for example, electrical voltages, temperatures, speeds of rotation of a machine, it is necessary to choose the appropriate sensor in each case and above all to adjust the measuring instrument in accordance with the characteristics of the quantity to be measured and the characteristics of the sensor. These adjustments are often very complex, and at the very least tedious. They are even more so when it is a matter of connecting several different sensors to the measuring instrument. Furthermore, when the measuring instrument used is an oscilloscope, the measurement results obtained by means of each of the sensors are displayed on the same screen. In this case, it is necessary to provide means enabling one to easily identify each of the results displayed on the screen.

However, each time one manually introduces characteristics of a sensor, the user of the measuring instrument runs the risk of making a mistake and either damaging the measuring instrument or displaying an erroneous result.

The aim of the invention is to propose a means enabling one to avoid the risks stated above.

The aim of the invention is attained with an arrangement of a measuring instrument with a family of sensors. Besides the measuring instrument and the sensors, this includes a connecting device enabling one to associate any one of the sensors with the measuring instrument. This connecting device has a power supply and data storage and processing devices enabling one to identify the sensor, to activate the protection, and to transmit data in analog or digital form, said devices being determined in accordance with the characteristics of the sensor.

The connecting device also has a multi-point connector, a first part of which is intended for establishing a link between the sensor and the data processing means for a data exchange necessary for identification of the sensor, for recognition of the protection of the instrument/sensor unit and possibly other functions.

A second part of the multi-point connector is intended for establishing a direct and insulated link for transmission of the measurement signals from the sensor to the measuring instrument.

This arrangement enables one to obtain at least the following functionalities: Plug & Play type connection, that is to say a connection requiring the user only to connect the apparatuses to be connected to one another, automatic identification of the type of sensor, establishment of active protection for the users with regard to the electrical dangers of the sensor/measuring instrument unit.

The arrangement according to the invention furthermore also permits one to supplement these useful and necessary functionalities with additional practical functionalities such as an on-board remote control means on the sensor or the function of lighting the work area of the sensors.

In the context of the present invention, we will designate equally as sensor any component, device, means, adaptor probe, etc., which are intended to be installed or placed or held temporarily at a place where a physical quantity such as electrical voltage, temperature, magnetic field, pressure, etc., is to be measured.

In the context of the present invention, we will consider oscilloscopes more particularly as measuring instrument, but without excluding known measuring instruments for displaying physical quantities on a display screen such as a graphic or alphanumeric screen or on a paper medium by means of a printer.

When a simple measuring instrument is used, such as a multimeter designed for measuring electrical voltages, electrical currents and ohmic resistances, it is sufficient for the user to connect two cables by one of their ends to the measuring instrument in terminals provided for this purpose, and to hold the two cables by their other ends, which are usually equipped with tips, on two points between which the physical quantity is to be measured. In order on the one hand to obtain the correct result, and on the other to prevent the measuring instrument from being damaged, the user has previously chosen the correct measurement range by means of an appropriate selector button.

For these common measuring instruments, it is not necessary to provide active protection devices for protecting the user, since, the measuring tips with which the cables are equipped generally provide sufficient protection.

However, when it is a matter of measuring physical quantities such as magnetic fields, high electrical voltages or strong electrical currents, or when physical quantities are measured by sampling, this passive protection is generally insufficient. In effect, the measuring capacity of a measuring instrument or of a sensor can be limited to certain modes of operation, for example, to certain measurement voltages, depending on the mode of operation chosen. If the user of the measuring instrument approaches such limits, it is necessary to be able to warn the user of the risk that he could run or to which he could expose the instrument.

Thus, in what is called active protection, the measuring instrument displays the limits of the sensor/instrument unit in a transitory window. A system for verifying that the physical quantity, particularly the corresponding electrical quantity coming from the sensor, conforms to the set limit, allows an alarm to be issued in case of exceeding the limit. It is therefore intelligent protection.

In effect, for these types of measurements it is necessary for the user of the measuring instrument to continually make sure that the measuring instrument is adjusted to the correct range of physical quantities, that the chosen sensor corresponds to the range of physical quantities to be measured, and that the sensor is suitably connected to the measuring instrument.

The arrangement according to the invention meets these needs with the means indicated above in the manner described hereafter with reference to the drawings. An embodiment of the arrangement according to the invention is represented in these drawings. These drawings show in particular:

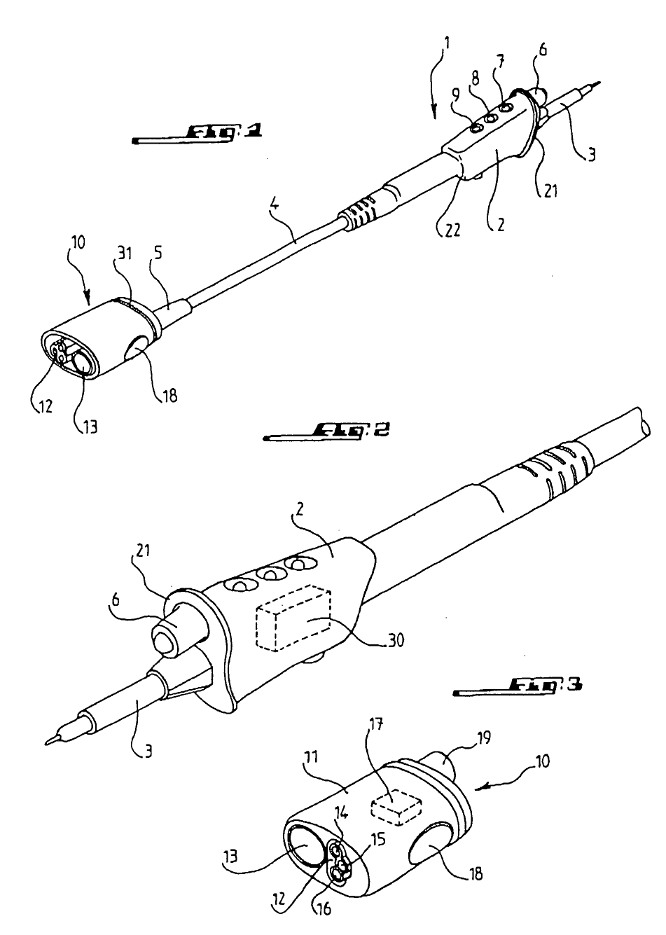

FIG. 1: a sensor with a connecting device,

FIG. 2: an oblique view of the sensor from the side of the sensor tip,

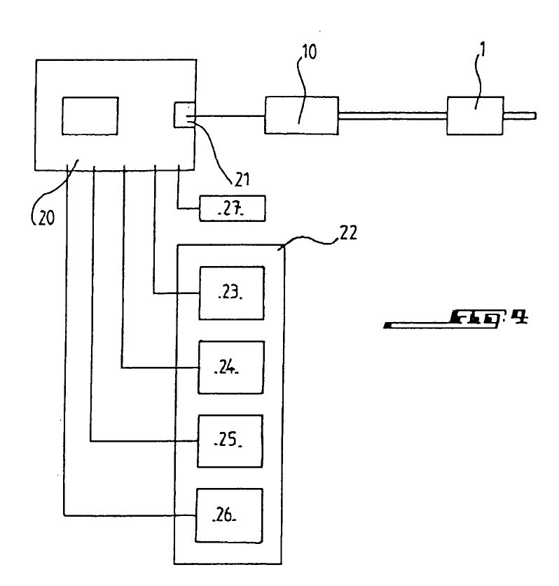

FIG. 3: an oblique view of the connecting device according to the invention, and

FIG. 4: the electrical diagram of a device according to the invention.

The arrangement according to the invention includes, besides measuring instrument 20, sensor 1 and connecting device 10 by means of which sensor 1 is connected to measuring instrument 20.

Sensor 1 represented in FIGS. 1 and 2 includes casing 2, generally cylindrical in shape, with two ends 21, 22. sensor 1 is provided on end 21 with measuring tip 3, and sensor 1 is provided on end 22 with connecting cable 4 which terminates with connector 5 on the end opposite from casing 2 of sensor 1. Sensor 1 also has lamp 6 arranged on end 21 of casing 2 of sensor 1, which is intended for lighting the work area of the sensor. Sensor 1 is provided on the upper surface of casing 2 with three control buttons 7, 8, 9 corresponding to electrical contacts allowing the user to activate particular functions during connection, as will be explained further on. One of these electrical contacts, actuated by the corresponding control button, can be used to turn lamp 6 on and off. The other functions can be chosen on the measuring instrument.

Connecting device 10 has management means 17 with a memory making it possible, from data recorded in this memory, to determine characteristics of the measurements to be made such as the nature of the signal to be measured, the measurement unit, a sensor scaling factor, and compensation data.

Sensor 1 furthermore has memory 30 containing the indications necessary for its automatic identification by the measuring instrument. For measuring instruments with a color display screen, memory 30 also indicates the color assigned to this sensor as recognition color so that the sensor measurement results are displayed in essentially the same color as that assigned to it. The color assigned to the particular sensor is then advantageously materialized by a removable colored part, which can therefore be replaced in case of change of assigned color. This part is fixed either on the connection end or on the gripping end. The initial assignment of a color and any change of this assignment are respectively recorded by the manufacturer and by the user of the measuring instrument so as to make the physical color and the computer color agree.

Sensor 1 is connected to the measuring instrument by means of connecting device 10 according to the invention so that the particular capacities of the sensors according to the invention can be utilized.

As represented in FIG. 3, connecting device 10 has casing 11 housing data processing and storage means 17 as well as multi-point connector 12, 13.

Data processing and storage means 17 makes it possible to identify sensor 1 and also, if necessary, to display the information necessary for active protection of the instrument/sensor unit in accordance with the characteristics of the sensor.

First part 12 of the multi-point connector is intended for establishing a link between sensor 1 and data processing and storage device 17 for a data exchange necessary for identification of sensor 1 and for display of the information necessary for active protection of the instrument/sensor unit, and possibly for other functions.

First part 12 of the multi-point connector has a termination with three lines 14, 15 and 16. This first part can be executed as a function of the number of lines to be run and the most practical terminations for the particular application. The three lines are generally used for grounding the transmission of signals, for the signals, and for the clock. At the same time, the electrical supply to sensor 1 makes possible the transformation of certain results in the sensor, for example, the transformation of a measured current or of a measured temperature into a voltage signal.

Second part 13 of the multi-point connector is intended for establishing a direct link, dielectrically isolated from the first part, for transmission of the measurement signals of sensor 1 to measuring instrument 20. It is generally executed as a standardized 50 Ω coaxial connection whose ground is separated from that of first part 12. Connecting device 10 is thus designed so that sensors other than those specially matched to measuring instrument 20 can also be used. However, when such generally available sensors are used, the advantages provided by the present invention are lost.

On the opposite side with respect to the multi-connector, connecting device 10 has plug 19 specifically adapted to connector 5 of sensor 1.

Connecting device 10 is furthermore equipped with two mechanical controls 18 intended for providing a snap-in connection of connecting device 10 to measuring instrument 20. These means are not represented in detail in order not to overload the description or the figures.

Likewise, connecting device 10 detects the disconnection of sensor 1, the function of identification of the sensor and the activation of at least one function for protection of the user of the measuring instrument, determined in accordance with the characteristics of the sensor, being effected only after interruption detection.

As represented in FIG. 4, the arrangement according to the invention includes means 27 for management of the measuring and display capacities of measuring instrument 20. This management means 27, for example, in the form of a microprocessor, monitors that the calibration of the measuring instrument corresponds to sensor 1 which is used, and at the same time determines the means of display and the information necessary for informing the user of the measuring instrument. It advantageously also includes an interruption detector intended for detecting the disconnection of sensor 1, as mentioned in the preceding paragraph.

In effect, in order not to overload the data transmission line, so as to avoid continual scanning of the service bus or buses and therefore to avoid electrical activity on the bus or buses during the measurements, since this activity can be detrimental in the case of certain measurements, and at the same time to avoid the loss of machine time for scanning, the configuration of the data transmission line and of the measures for protecting the user is initialized only when an interruption signal is sent from sensor 1 to measuring instrument 20.

Thus, when sensor 1 is connected to measuring instrument 20 by means of connecting device 10, the measuring instrument is automatically adjusted in accordance with the type of sensor which is used. The reading of the contents of memory 17 of the sensor, in which all the characteristics necessary for the correct functioning of the sensor and the measuring instrument are recorded, is triggered by the connection. This results more particularly in activation of the corresponding data transmission line, in the determination of the nature of the signal to be measured, in the determination of the measurement unit and of a sensor scaling factor, and in the determination of the re-calibration periods. Furthermore, if there is not conformity between the measured quantity and the set limit, an alarm is triggered.

The arrangement according to the invention furthermore includes information means 22 making available to the user of measuring instrument 20 the information necessary for active protection of the unit formed by measuring instrument 20 and sensor 1, and the results of the measurements made by means of sensor 1.

Thus, information means 22 includes, for example, numerical display screen 23 intended for the display of the information necessary for active protection of the measuring instrument/sensor unit. Information means 22 is moreover connected to a means of graphic display of the measurement results. This link makes it possible to display the information necessary for active protection of the measuring instrument/sensor unit either before display of the measurement results, or in a repeated manner, with predetermined or variable periods, during display of the measurement results. This information display can take place either in response to an instruction given by the information means, for example, cyclically, or each time a measurement series begins, or in response to a manual instruction triggered by the user of measuring instrument 20.

Information means 22 can also include color printer 26 making possible a graphic and alphanumeric presentation of the measurement results in hard copy, such as on paper. Information means 22 can also include screen 25 making possible both a graphic display and an alphanumeric display of the measurement results.

In the text above, the different information means, alphanumeric display screen 23, graphic display means 24, color screen 25, and printer 26, are given as examples of commonly used information means. The formulation “can include” has been used to indicate that the person who implements the present invention is free to choose the information means that best meet the needs of the particular measurements to be made, and that the choice of one or more of these means to be used simultaneously or of another information means does not matter and does not depart from the principle of the present invention.

The arrangement according to the invention furthermore includes some means making it possible to activate a function to be chosen from a pre-defined panel of functions. This means advantageously functions by interruption of the electrical link between sensor 1 and measuring instrument 20. The means can in particular include electrical contacts 7, 8 and 9 and the corresponding control buttons arranged on casing 2 of sensor 1. This possibility is added to the automatic control according to which identification of the sensor and calibration of the measuring instrument in accordance with the sensor take place automatically. This additional possibility allows one to use the sensors with multiple capacities as well as to control the arrangement during its use in accordance with different manners of measuring, for example, for different types of sampling.

1. A measuring instrument comprising:
plurality of sensors; and
a connecting device enabling association of any of the sensors with the measuring instrument, and including data processing means for identifying each of the sensors and activating at least one function for protection of a user of the measuring instrument, determined in accordance with characteristics of a selected one of the plurality of sensors, the connecting device including a multi-point connector, having a first part for establishing a link between the sensor selected and the data processing means for a data exchange to identify the sensor selected and the activation of the protection and having a second part for establishing a direct link for transmission of measurement signals from the sensor selected to the measuring instrument, the second part being dielectrically isolated from the first part.

2. The measuring instrument according to claim 1, including means for management of measurement and display capacities of the measuring instrument in accordance with the sensor selected, the management means being located in the measuring instruments.

3. the measuring instrument according to claim 1, including information means making available to the user information necessary for active protection of the measuring instrument and the sensor selected, and measurement results.

4. The measurement instrument according to claim 3, wherein the sensor selected includes a lamp on an end of a casing including the sensor selected, for lighting a work area of the sensor selected.

5. The measuring instrument according to claim 3, information means is connected to a device for graphic display of measurement results, and display of information for protection of the measuring instrument and the sensor selected, before display of the measurement results or during display of the measurement results, according to an instruction given by the information means.

6. The measuring instrument according to claim 1, wherein each sensor includes a memory containing information for automatic identification by the measuring instrument of the sensor selected and indication of a color assigned to the sensor selected so that measurement results of the sensor selected are displayed in essentially the color assigned to the respective sensor selected.

7. The measuring instrument according to claim 1, wherein the connecting device includes management means having a memory storing data for determining characteristics of measurements to be made, including nature of a signal to be measured, measurement unit, sensor scaling factor, and compensation data.

8. The measuring instrument according to claim 1, including means for management of re-calibration periods of the measuring instrument.

9. The measuring instrument according to claim 1, wherein the connecting device includes an interruption detector for detecting disconnection of the sensor selected from the measuring instrument, identification of the sensor selected, and the activation of at least one function for protection of the user of the measuring instrument, determined in accordance with characteristics of the sensor selected, effected only following detection of a disconnection.

10. The measuring instrument according to claim 1, wherein each sensor includes electrical contacts for activating a measurement function chosen from panel of functions, by sending a signal of interruption of the electrical link connecting the sensor selected to the measuring instrument upon connection of the sensor selected to the measuring instrument.

11. The measuring instrument according to claim 1, wherein each of the sensors includes a color characteristic provided by a removable part.
